(19) United States
(12) Patent Application Publication
(10) Pub. No.: US 2007/0300026 A1
(43) Pub. Date: Dec. 27, 2007

(54) Synchronous backup device and method used for storage device

(76) Inventor: Kwok-Yan Leung, Willowdale (CA)

Correspondence Address: BIRCH STEWART KOLASCH & BIRCH, PO BOX 747, FALLS CHURCH, VA, 22040-0747, US

(21) Appl. No.: 11/473,270

(22) Filed: Jun. 23, 2006

(51) Int. Cl. G06F 12/16

(52) U.S. Cl. 711/162

(57) ABSTRACT

A synchronous backup device and a method used for a storage device, mainly used to write/update synchronously a main storage device and a backup storage device utilizing data from the host, and perform data backup while writing the data. In writing the data, the data position concept is used to analyze which portions of the storage device have the written-in data, so that in carrying out data restoration at a later time, only the portions having data have to be restored, thus the portions having no data do not need to be restored.

### BACKGROUND OF THE INVENTION

1. Field of the Invention

The present invention relates to a backup device and a method, and in particular to a synchronous backup device and a method used for a storage device.

2. The Prior Arts

In the design of the Redundant Array of Independent Disk (RAID), the RAID structure is composed of a RAID hard disk set made of several hard disks, and the data to be stored is distributed in various different hard disks according to calculation. Therefore, in case that one of the set of RAID hard disks is damaged, its original contents can be calculated and derived from that of other RAID hard disks. In this manner, only a blank hard disk has to be prepared and reserved in advance as a backup, so that the original contents of the damaged hard disk can be derived and restored, thus the entire set of RAID hard disks may resume normal operation immediately.

However, according to the ordinary data backup/restoration technology, even in the data restoration of the set of RAID hard disks, each of the sectors contained therein must be transferred entirely from a backup hard disk to a main hard disk, even the sectors having no data contained therein must be transferred and written into blank sectors of hard disk during data restoration. As such, conventionally, for both the ordinary hard disk and RAID hard disk set, the data restoration process is quite time consuming when large amount of data is involved. Though, in the prior art, the process of data backup and restoration is very time consuming, yet if only the sectors having data is backuped and restored, then the backup and restoration efficiency can be improved significantly.

Though, presently, the hard disk backup and restoration technology is performed only for the sectors containing data, however, in executing the data backup and restoration, the original operation must be stopped, so the backup procedure may only be executed in the backup mode and not in a real-time manner. The system may be restored to the original operation state only after the termination of the backup process. As such, the users are required to learn and be familiar with the complicated backup operation. Besides, in executing the backup procedure, the original operation must first be stopped, thus the backup operation is not performed in a strictly real-time manner.

### SUMMARY OF THE INVENTION

In view of the shortcomings and drawbacks of the prior art, the objective of the present invention is to provide a synchronous backup device and a method used for a storage device. The essence of the present invention is that, the data from the host is written into a main storage device and a backup storage device synchronously, thus data backup is performed simultaneously with data writing. In this way, there is no need to stop the original operation, and data backup can be performed any time in a real-time manner. In the process of writing data, the data position concept is utilized to analyze and note that the data is written into which portion of the storage device, so that in the data restoration to be executed in the future, only the portions having data have to be restored. In this manner, both time and memory used for data restoration can be reduced significantly.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a synchronous backup device used for a storage device according to an embodiment of the present invention;

FIG. 2 is a schematic diagram of disk space allocation according to an embodiment of the present invention;

FIG. 3 is a schematic diagram of a working area and a position index area according to an embodiment of the present invention; and

FIG. 4 is a schematic diagram of a synchronous backup device used for a storage device according to another embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

In the following illustration, the synchronous backup device and the method used for a storage device of the present invention will be described in detail with reference to the attached drawings.

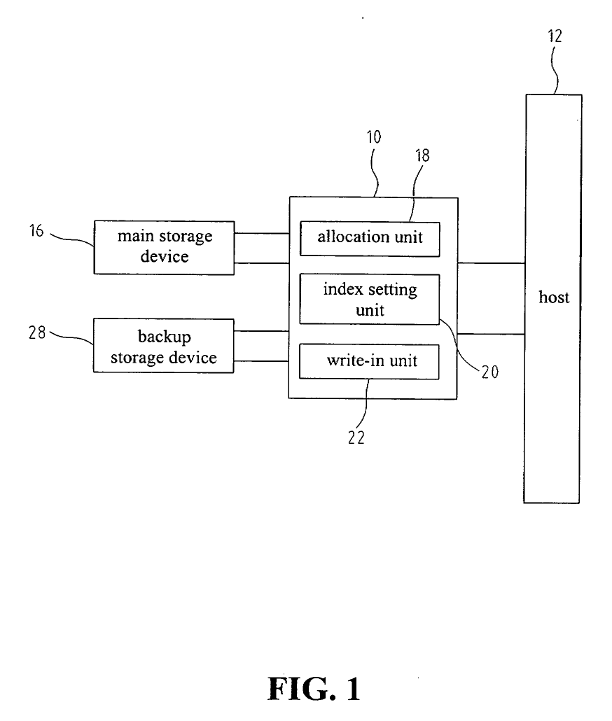

Firstly, referring to FIG. 1. FIG. 1 is a schematic diagram of synchronous backup device used for a storage device according to an embodiment of the present invention. As shown in FIG. 1, the synchronous backup device 10 is composed of an allocation unit 18, an index setting unit 20, and a write-in unit 22; each of which connected respectively to a host 12, a main storage device 16, and a backup storage device 28 for transmitting data and information.

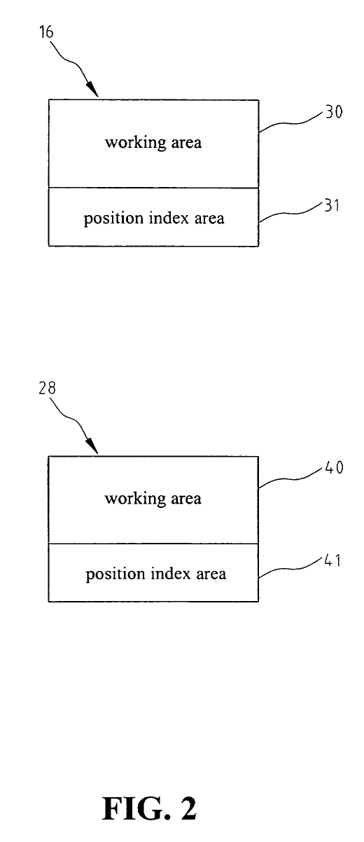

Next, referring to FIG. 2. FIG. 2 is a schematic diagram of disk space allocation according to an embodiment of the present invention. According to an allocation instruction from the host, the allocation unit 18 of FIG. 1 is utilized to allocate the entire disk space (namely, the storage space composed of a plurality of sectors) into working area 30, position index area 31, working area 40, and position index area 41. As such, the purpose of the afore-mentioned allocation instruction is to indicate respectively the sector quantity utilized by the working area and the position index area. For the convenience of operation and implementation, the synchronous backup device 10 of the present invention will automatically perform the space allocation for working areas 30 and 40, position index areas 31 and 41 at a ratio of 100:0.1, thus there is no need for the user to perform similar task through the allocation unit 18.

In brief, the essence of the synchronous backup device and the method used for the storage device is that writing/updating synchronously (equivalent to the real time synchronous backup) the main storage device 16, backup storage device 28 by making use of the data from the host 12; meanwhile, restoring the portions of the data storage device actually having data by making use of data position concept and principle (namely, whether the sector does contain data). In this way, not only the data backup efficiency is increased, but the data restoration efficiency is also raised. Consequently, there is no need for the user to stop the original operation, thus the backup can be performed synchronously in a real-time manner.

In the following, the data position concept and principle will first be described briefly, that is used to verify if the data is indeed stored in the sector. Then the following items will be described in sequence as follows: data restoration, data read/write, and the report to the host 12 as to whether data write/update is complete.

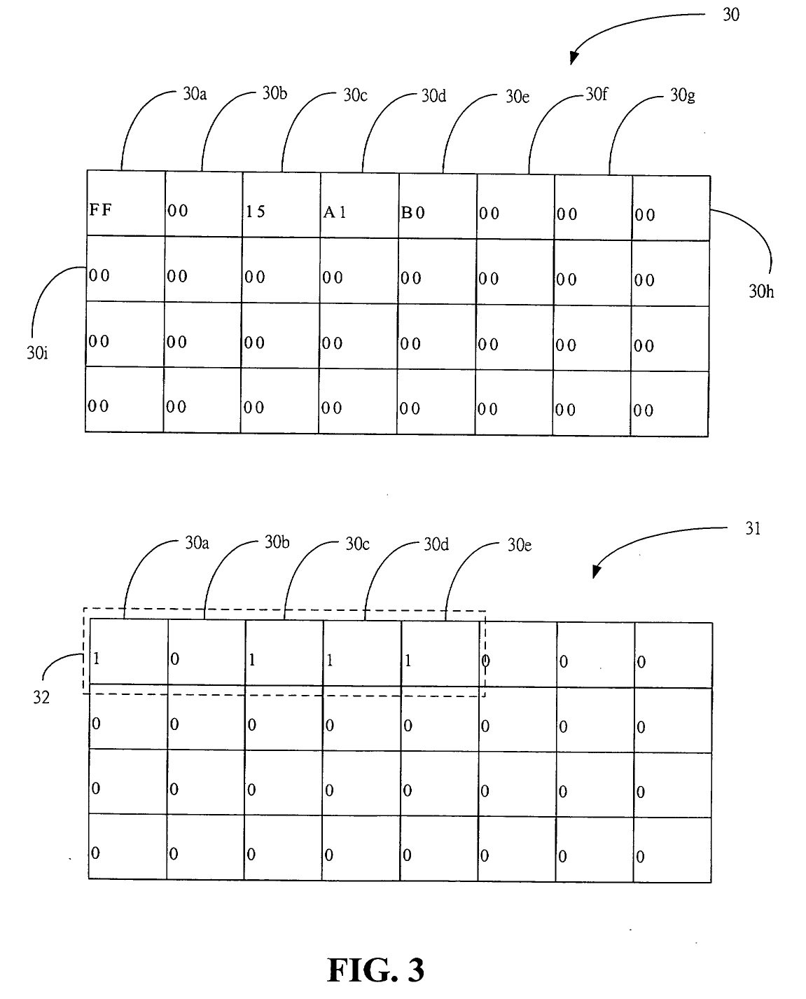

Then, referring to FIG. 3 for a schematic diagram of a working area and a position index area according to an embodiment of the present invention. As shown in FIG. 3, the sectors 30a to 30e of the working area are written/updated as “FF”, “00” (“00” indicates that no data are written/updated), “15”, “A1”, and “B0” by the operation system; however, for the sectors 30f to 30i, no data has been written/updated.

In order to reduce the time required for data restoration and raise the restoration efficiency, while the operation system is writing/updating the working area 30 (via the synchronous backup device 10), such as the sector 30a (working area 40 also has its own corresponding sector, however, in this embodiment, the working area 30 of the main storage device 16 is taken as an example), the index setting unit 20 will record the data position of sector 30a in the position index area 31. As shown in FIG. 3, the contents at data position 32 of the position index region 31 indicates that if the sectors 30a to 30f are in the write/update state. Therefore, if as mentioned earlier, “FF” is written/updated into sector 30a of working area 30, then the content “1” at data position in the position index area 31 indicates that write/update has been performed for the sector 30a. Otherwise, if at sector 30b, no data write/update has been performed, then the content at data position in the position index area 31 corresponding to the magnetic region 30b is set to “0”.

However, in the above description, for the data positions in the position index areas 31 and 41, only after the write-in unit 22 is utilized to write/update the data coming from host 12 into the working areas 30 and 40 of the main storage device 16 and the backup storage device 28 respectively, then the index setting unit 20 is used to write/update the data position into the position index areas 31 and 41 of the main storage device 16 and the backup storage device 28.

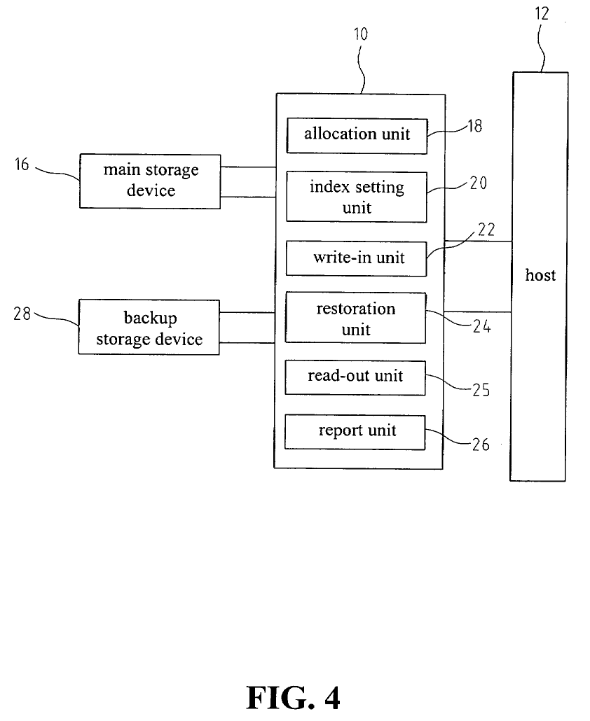

Finally, referring to FIG. 4 for a schematic diagram of a synchronous backup device used for a storage device according to another embodiment of the present invention. As shown in FIG. 4, the synchronous backup device 10 includes a restoration unit 24, a read-out unit 25, and a report unit 26, in addition to an allocation unit 18, and index setting unit 20, and a write-in unit 22 already shown in FIG. 2.

As shown in FIG. 4, in case that a data restoration is required, the restoration unit 24 is utilized to restore the data backuped in the sectors of the working area 40 of the backup storage device 28 into the corresponding sectors in the working area 30 of the main storage device 16, as based on the data position in the position index area 41 of the backup storage device 28; and then restore the data position in the position index area 41 of the backup storage device 28 into the position index area 31 of the main storage device 16.

Furthermore, in case that data reading is required at the host 12, then the read-out unit 25 is utilized to read out the data required from the working area 30 of the main storage device 16.

As with the ordinary hard disk controller, the synchronous backup device 10 used for the storage device according to the present invention is utilized to generate the write-in completion report via a report unit 26, so that the synchronous backup device 10 is compatible with any kind of storage device. To be more specific, only after verifying that the date required has been written into the working areas 30 and 40, and also after verifying that the related data positions have been written/updated into the position index areas 31 and 41, then the report unit 26 will generate a report and send it to the host 12 indicating that data has been written into the storage device.

Moreover, upon receiving from the host 12 the write-in request, analyzing and obtaining the related data position, the index setting unit 20 will first store the data position temporarily into the buffer memory (not shown), and then write the data position into the position index area 31 of the main storage device 16 and the position index area 41 of the backup storage device 28 respectively. Or, alternatively, the index setting unit 20 may first write the data positions directly into the position index area 31 of the main storage device 16, and then copy the data positions of the position index area 31 into the position index area 41. As to the date write-in, the write-in unit may first write data directly into the main storage device 16, and the backup storage device 28 synchronously, or it may first store the data temporarily into a buffer memory, and then write the data into the main storage device 16 and the backup storage device 28 at a later time.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. A synchronous backup device used for a storage device, which is used to write/update synchronously a main storage device and a backup storage device utilizing the data from a host, comprising:
an allocation unit, used to allocate a plurality of sectors in said main storage device, said backup storage device into a working area and a position index area respectively according to an allocation instruction;
a write-in unit, used to write/update said working areas of said main storage device and said backup storage device respectively by making use of the data from said host; and
an index setting unit, used to write/update data into specific sectors in said working area, meanwhile, write/update said data position into said position index area of said main storage device and said backup storage device, wherein the contents at said position index area are used to indicate whether the corresponding sectors are in the write/update state.

2. The synchronous backup device used for a storage device as claimed in claim 1, further comprising:
a restoration unit, used to restore said sectors backuped in said working area of said backup storage device into said corresponding sectors in said working area of said main storage device, as based on said data position in said position index area of said backup storage device, and then restore said data position in said position index area of said backup storage device into said position index area of said main storage device.

3. The synchronous backup device used for a storage device as claimed in claim 1, further comprising:
a read-out unit, utilized to read out only the data stored in said working area of said main storage device.

4. The synchronous backup device used for a storage device as claimed in claim 1, wherein upon receiving the write-in request from said host, analyzing and obtaining the related data position, the index setting unit will first store the data position temporarily into the buffer memory, and then write said data position into said position index area of said main storage device and said position index area of said backup storage device respectively.

5. The synchronous backup device used for a storage device as claimed in claim 1, wherein said write-in unit is used to first write/update the data from said host to said working areas of said main storage device and said backup storage device, then said index setting unit is used to write/update said data position into said position index areas of said main storage device and said backup storage device.

6. The synchronous backup device used for a storage device as claimed in claim 1, further comprising:
a report unit, used to verify that the data required have been written into said working areas and, and also verify that said related data positions have been written/updated into said position index areas and, and then generate a report and send it to the host indicating that data has been written into the storage device.

7. The synchronous backup device used for a storage device as claimed in claim 1, wherein said allocation instruction is mainly used to designate the sector amount occupied by said working areas and said position index areas.

8. A synchronous backup method used for a storage device, which is used to write/update synchronously a main storage device and a backup storage device utilizing the data from host, comprising the steps of:
allocating a plurality of sectors in said main storage device, said backup storage device into a working area and a position index areas respectively according to an allocation instruction;
writing/updating said working areas of said main storage device and said backup storage device respectively by making use of the data from said host; and
writing/updating data into specific sectors in said working area, meanwhile, writing/updating said data position into said position index areas of said main storage device and said backup storage device, the contents at said position index area is used to indicate whether the corresponding sectors are in the write/update state.

9. The synchronous backup method as claimed in claim 8, further comprising the steps of:
restoring the said sectors backuped in said working area of said backup storage device into said corresponding sectors in said working area of said main storage device, as based on said data position in said position index area of said backup storage device; and
restoring said data position in said position index area of said backup storage device into said position index area of said main storage device.

10. The synchronous backup method as claimed in claim 8, further comprising the step of reading out only the data stored in said working area of said main storage device.

11. The synchronous backup method used for a storage device as claimed in claim 8, wherein said write-in unit is used to first write/update the data from said host to said working areas of said main storage device and said backup storage device, then said index setting unit is used to write/update said data position into said position index areas of said main storage device and said backup storage device.

12. The synchronous backup method used for a storage device as claimed in claim 8, further comprising the step of:
reporting to the host that data have been written into the storage device after verifying that the data required have been written into said working areas, and also after verifying that said related data positions have been written/updated into said position index areas.
